(19) United States
(12) Patent Application Publication
(10) Pub. No.: US 2013/0272504 A1
(43) Pub. Date: Oct. 17, 2013

(54) X-Ray Dose Reduction by Controlled Shutter Speed

(71) Applicant: Meir Deutsch, Vancouver (CA)

(72) Inventor: Meir Deutsch, Vancouver (CA)

(21) Appl. No.: 13/862,791

(22) Filed: Apr. 15, 2013

Related U.S. Application Data
(60) Provisional application No. 61/686,954, filed on Apr. 16, 2012.

(51) Int. Cl. G21K 1/04

(52) U.S. Cl. CPC G21K 1/04
USPC 378/150

(57) ABSTRACT

A fast moving X-Ray shutter has four independently controlled blades defining a Region of Interest (ROI). The ROI area receives the normal X-Ray dose and is exposed at the machine's X-ray pulse frame rate. The ROI can be automatically controlled based on image contents using computer vision techniques. Periodically the shutter blades retract at a controlled speed, exposing the area outside the ROI to a lower, non-uniform, exposure. The non-uniformity in this background exposure is dynamically corrected by a look-up table. The displayed image is a seamless combination of the ROI image and the corrected background image. The displayed image has slightly lower resolution outside the ROI but better resolution (as compared to standard fluoroscopy practices) in the ROI because of reduced scattering.

### FIELD OF THE INVENTION

The invention relates to the medical field and in particular to the art of continuous X-Ray procedures such as fluoroscopy.

### BACKGROUND OF THE INVENTION

The increased use of minimally invasive surgery caused an increase in the use of fluoroscopy, exposing the patients, doctors and support staff to ever increasing amounts of radiation.

A typical fluoroscopy unit includes a frame holding the X-Ray source and detector, a patient on a bed and a workstation. The units are known as “C-arm” units because of the C-shaped frame. Existing fluoroscopy systems expose a certain field-of-view (FOV) defined by setting the collimator blades. This operation is sometimes referred to as “coning” (setting the aperture cone). The physician performing the fluoroscopy is usually interested in a smaller region-of-interest (ROI) within the FOV, however the larger image is required for orientation and periodic monitoring. Modern fluoroscopy machines use flat panel detectors and pulsed X-ray tube operation. Current generation fluoroscopy machines determine the x-ray tube current and pulse length automatically while the pulse's frequency is left under operator's control. This is illustrated in FIG. 1 in which all x-ray pulses expose the full FOV.

Prior art for reducing total radiation without limiting the viewing area is disclosed in U.S. Pat. No. 7,983,391 which adds a fast moving shutter that can set a different exposure area for every X-ray exposure pulse. Using this shutter, the system can expose the small ROI for few consecutive pulses and open up the shutter to the full collimator FOV for a single pulse, as shown in FIG. 2. For most of the pulses the shutter is partially closed, allowing only a small ROI to be exposed. Periodically the shutter is opened for one pulse to update the background image. Full details are given in the above mentioned patent. Image blending software that runs on the machine's workstation blends the ROI (which is a “live” sequence) with the surrounding taken during the full-FOV exposure pulse. The shutter can be placed anywhere in the X-ray beam path, but the preferred location is between the X-ray tube and the collimator in order to minimize the size of the shutter. The concept from U.S. Pat. No. 7,983,391 works well in procedures performed on slow-moving body parts, such as the brain (for example during brain aneurysm coil embolization). For areas with rapid change, such as cardiac procedures, it will not capture all the motion in the area outside the ROI. The current invention overcomes this problem.

The ability to change the FOV or “coning” dynamically, at the same rate as the X-Ray pulses, can also be used while doing Computerized Tomography (CT) scans. In this disclosure, the term “dynamically” should be broadly interpreted as any situation where the images are changing while the system is being used. In a CT scan the viewing position changes frame by frame, therefore the collimation should also change with it for optimal results. A regular collimator is not sufficiently fast to do that but the same shutter used for dose reduction in this invention can handle the needed “dynamic coning”.

There exists prior art where an image is acquired with moving shutter blades, such as Raskar's flutter shutter camera, described in the paper “Coded exposure photography: motion deblurring using fluttered shutter”. The aforementioned invention opens and closes the shutter multiple times during the desired exposure time in a rapid irregular binary sequence to correct for motion blur. We differ from Raskar by varying the motion of the shutter in a continuous or piecewise fashion. Furthermore, the resulting effect of our disclosed invention is a non-uniform exposure or intensity profile which, in the preferred embodiment, reduces the overall radiation exposure of patient and staff, while Raskar's invention corrects for image blurring.

Static filters have been shown in prior art to change the exposure profile of X-Ray images, such as in U.S. Pat. No. 5,278,887, in the paper by Rudin et al. titled “Region of Interest Fluoroscopy”, Medical Physics Vol. 19, p 1183 (1992), Hasegawa's paper titled “Digital beam attenuator technique for compensated chest radiography”, Radiology, V 159(2), p 537 and Labbe et al. in the paper titled “The x-ray fovea, a device for reducing x-ray dose in fluoroscopy”, Medical Physics Vol. 21, p 471 (1994). We differ from these prior arts by acquiring X-Ray images while shutter blades (effectively an attenuating filter) are moving to create the desired exposure profile, which offers more flexibility in terms of the characteristics of the exposure profile and the ability to dynamically change said profile.

Moving filters exist in prior art in the field of X-Ray imaging, such as WO Patent 96/27195, wherein a pinwheel-like filter is rotated to uniformly reduce the radiation exposure. The aforementioned invention has a static ROI located in the center of the X-Ray image. We teach away from this example by allowing the exposure profile to match a varying region of interest using moving shutter blades, which result in a non-uniform exposure profile that can by dynamically adapted to suit the user's preference. Another example of a dynamic filter is U.S. Pat. No. 7,308,073 is a sac filled with x-ray attenuating fluids that can be deformed during an X-Ray or CT scan using a rotary actuator. We differ from the aforementioned patent by using shutter blades instead of a deformable sac to create a continuously varying non-uniform exposure profile, allowing greater speed and better control over said profile.

### SUMMARY OF THE INVENTION

A fast moving X-Ray shutter has four independently controlled blades defining a Region of Interest (ROI). The ROI area receives the normal X-Ray dose and is exposed at the machine's X-ray pulse frame rate. The ROI can be automatically controlled based on image contents using computer vision techniques. Periodically the shutter blades retract at a controlled speed, exposing the area outside the ROI to a lower, non-uniform, exposure. The non-uniformity in this background exposure is dynamically corrected by a look-up table. The displayed image is a seamless combination of the ROI image and the corrected background image. The displayed image has slightly lower resolution outside the ROI but better resolution (as compared to standard fluoroscopy practices) in the ROI because of reduced scattering.

### BRIEF DESCRIPTION OF THE DRAWINGS

FIG. 1 is a schematic depiction of a series of images acquired using current fluoroscopy practices.

FIG. 2 is a schematic depiction of a series of images acquired using the method of U.S. Pat. No. 7,983,391.

FIG. 3 is a schematic depiction of a series of images acquired using the method of the invention.

FIG. 4 is a block diagram of a fluoroscopy system incorporating the invention.

FIG. 5 is a schematic depiction of the invention, including the exposure correction process.

FIG. 6 is a plan view of a shutter suitable for the invention.

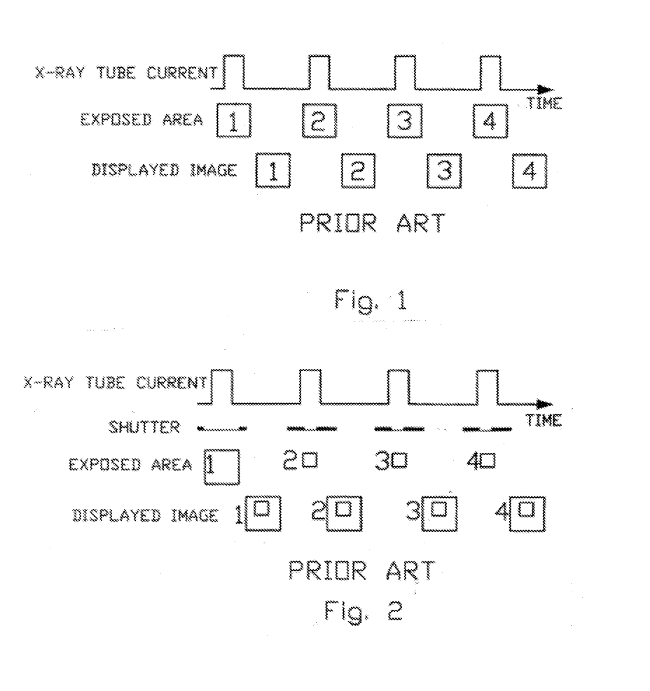

### DETAILED DISCLOSURE

This application is an improvement on U.S. Pat. No. 7,983,391 which is hereby incorporated by reference in its entirety. The improvement allows a use of a shutter controlled ROI to be applied to procedure having fast moving body organs outside the ROI, such as the beating heart during cardiac interventions or when a varying x-ray exposure profile is required. The area outside the ROI is imaged at a lower exposure dose, achieved by using shorter exposure time. Exposure outside the ROI could be different at every location depending on the blade retraction profile. Reducing the dose will reduce the image quality, but the area outside the ROI is of lesser importance to the physician performing the procedure. It was found that even a 10× reduction in the X-Ray dose outside the ROI produces acceptable image. The part of the image inside the ROI actually improved when the ROI is reduced because of reduced X-Ray scattering. We performed an initial experiment to validate this assumption.

The invention takes advantage of the fact that if each blade of a fast shutter is independently controlled, typically by a position feedback system, the transition between the ROI position of the blades and the full FOV position can also be precisely controlled. When this transition is performed at constant speed a tapered exposure profile is created for the area outside the ROI, i.e. the further the point is from the ROI the lower the exposure it receives will be.

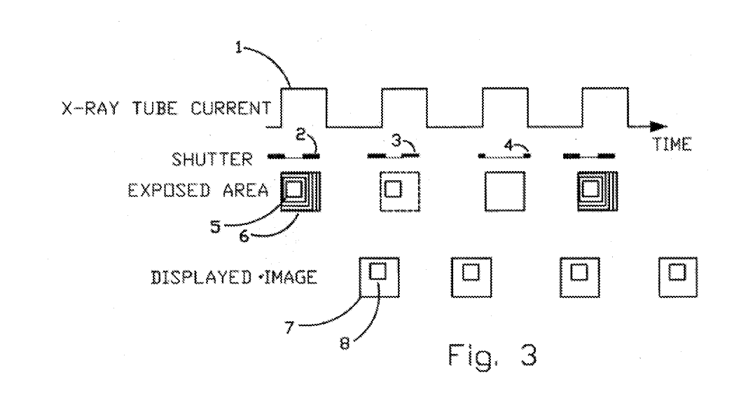

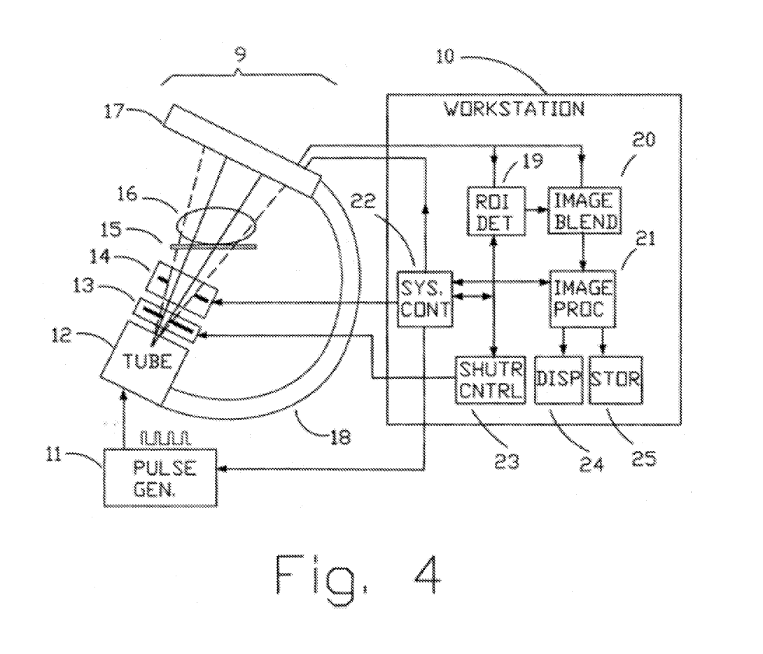

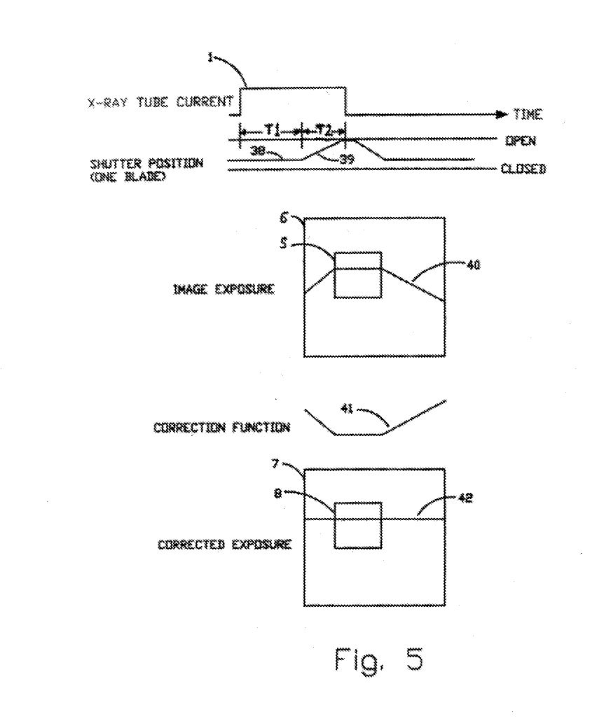

Referring now to FIG. 3, a sequence of full intensity X-Ray pulses 1 is limited to expose only a small ROI 5 by the action of a fast shutter having a limited opening 2. During pulse 1 shutter opening 2 increases from ROI 5 to full FOV 6. The high quality ROI image 5 is blended with the Full FOV image 6 to form a composite image 7 in which the ROI 8 is exposed at a higher radiation dose than the background, which is the area outside the ROI. The fall-off in intensity in the image outside the ROI can be calculated accurately based on shutter speed and the correction applied to the area outside the ROI. The area outside the ROI will appear slightly noisier than a conventional image while the ROI area will be sharper than a conventional image as the narrow collimation angle reduces scatter. The process is shown in more detail in FIG. 5. X-Ray pulse 1 is divided into two parts of durations T1 and T2. During period T1 the shutter stayed partially closed to define the ROI 5. This is shown as part 38 of FIG. 5. During T2 the shutter opens at a constant speed as shown by part 39 of same graph. This process created an image exposure profile 40. Since the profile is known a correction function 41 can be computed and when multiplied by the exposure correction function 40 created a corrected exposure 42. Lines 40 and 42 represent single scan line of the image detector, clearly the full exposure function is two dimensional. After the shutter opens to the full FOV it returns to the ROI position in preparation for the next X-Ray pulse. This is also shown in FIG. 5 graph.

Returning now to FIG. 3, it may be desired to incorporate different exposure modes in the same pulse sequence. For example, if the rate of background change is slow the shutter can stay in the ROI position for several X-Ray pulses. This is shown as shutter position 3. Sometimes it may be desired to keep the shutter fully open for the whole duration of one X-Ray pulse. This is shown as shutter position 4. Such a mode is needed to form an accurate exposure correction function.

Referring now to FIG. 4, a typical fluoroscopy system comprises of a C-arm assembly 9 and a workstation 10. The patient 16 is placed on a bed 15 between the X-Ray tube 12 and detector 17, typically a flat panel solid state detector. A fast shutter 13 is inserted between the X-ray tube 12 and the existing collimator 14. In cases where the system (9) has a collimator 14, the collimator is used to set the full FOV the conventional way, the shutter 13 defines the area of interest according to a manual or automatic setting. An automatic setting can be based on image recognition, tool recognition (such as tip of catheter or stent), motion analysis or any one of the many methods used in computer vision. A manual setting can be based on any contact or non-contact input device, including touch screens, speech recognition and eyeball tracking. Recently interfaces capable of recognizing hand gesturing became available (such as Microsoft Kinect) which could be very suitable for defining an ROI without contact. Non-contact interfaces are desirable, of course, to preserve sterility in the operating room.

The different dose pulses are generated by pulse generator 11 controlled by workstation 10. The main functional blocks in the workstation are ROI detector 19, Image Blending 20, Image Processing 21, System Control 22, Shutter Control 23, Display 24 and storage device 25. Most of these blocks are implemented in software. The only modules that do not exist in a standard fluoroscopy system are 13, 19, 20 and 23. An example of image blending is using a soft transition between the two regions, aided by the natural blur zone of about 10-20 mm created by the finite size of the X-Ray source. System geometry defines the blur zone. Since the area next to the ROI is exposed at the same level as the ROI, natural seamless blending results. Other methods of blending the images can be used. For example, the boundary of the ROI can be detected in the image data during the first part of the pulse (T1 in FIG. 5) by setting a threshold on the data acquired with the shutter closed. Such a threshold can be set, by the way of example, at 50% of the peak detector signal. A band slightly wider than the transition zone is defined around the threshold, with the threshold pixels at the center of the band. The pixels inside the band is discarded and replaced by exposure corrected full image data. Another alternative to blending the ROI into the full image is to place a visible border around the ROI, denoting to the user the high resolution area. Such a border masks the undesired border formed by imperfect blending.

Typical distance between the fast shutter 13 and the X-Ray point source is 60-100 mm. Typical source focal size is 0.3-1.5 mm. The Shutter Control activates the shutter blades to form an opening of the size and location determined by the ROI detector 19. Note that current generation fluoroscopy machines include an AEC (Automatic Exposure Control) mechanism that analyzes the image from the detector and adjusts the x-ray tube parameters to achieve optimal image quality, as determined by the machine pre-set manufacturer tables. One possible solution is to allow integration with the device in FIG. 4 is to limit this AEC mechanism to analyze the image pixels exposed during the first part of the pulse, so the machine won't react as a result of the lower image quality that results from the lower dose exposure towards the end of the pulse.

The preferred embodiment uses an electromagnetic actuator to move the shutter blades. Other actuators, such as pneumatic or hydraulic, can be used as well. An X-ray opaque liquid, such as Angiography dyes, can also be fed between two X-ray transparent plates to serve as an actuator blade. The preferred actuator design is similar to the one used in computer disc drives (“hard drives”). This actuator has a fast response time of about 10 ms, low cost and high reliability. Since it is well known no further details are needed.

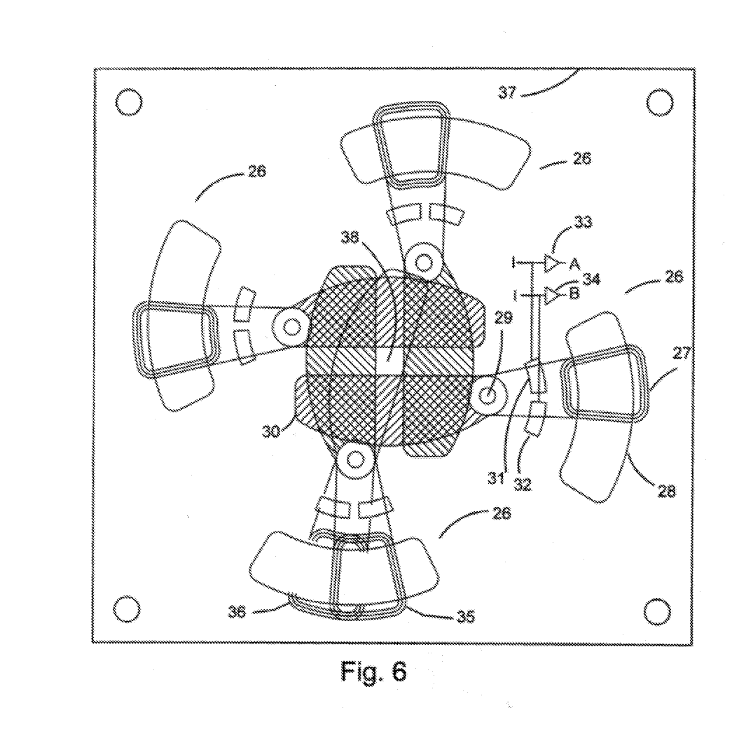

FIG. 6 shows a shutter mechanism based on such actuators. A plurality of rotary actuators 26 are mounted on plate 37. The number of actuators can be from 3 to over 10 with the preferred number being 4 units. Each actuator 26 controls a blade 30 made from X-ray absorbing material such as lead. It may be desirable to laminate the lead to a stiffer material such as thin stainless steel or aluminum. By the way of example, a 1 mm lead sheet can be bonded by soldering or using polyurethane adhesive to a 0.4 mm spring tempered stainless steel sheet. The actuator comprises of a moving coil 27 pivoting on bearing 29 inside a magnetic field created by a permanent magnet 28. It is desirable to add a position sensor to the actuator, as it has to operate as part of a servo system under the control of the Shutter Control unit. A suitable sensor is a differential capacitance sensor comprising two electrodes 31 and 32 placed above the pivoting part without touching it. A typical gap between the electrodes and the moving part is 0.1-0.5 mm. It is assumed that the whole actuator is electrically grounded, therefore the capacitance from each electrode to ground is measured by monitoring the AC impedance, which is inversely proportional to the capacitance. If a constant AC current I is fed to the electrodes, the voltage, which is proportional to the impedance, can be sensed by amplifiers 33 and 34, creating a signal A and B inversely proportional to the overlap area. Such capacitive sensors are well known. The position of the pivoting arm is determined by the formula: (1/A−1/B)/(1/A+1/B) which equals to B−A/A+B. This ratio eliminates any dependence on amplitude of frequency stability. Typical values for the current are 10 uA to 1 mA at a frequency of 100 KHz to 1 MHz. Other position sensor such as optical encoders or inductive encoders can be used as well. The motion of the blade forming the aperture 38 is shown by the coil moving from position 35 to position 36, closing the aperture 38 completely. The aperture is not a square but an arbitrary shaped four sided polygon. More regular shapes can be achieved by more blades or by using rectilinear actuators. Since the software controls the blade position the shape of the arbitrary polygon is known and, if desired, the ROI image can be trimmed to a rectangle. If a true rectangular aperture is desired rectilinear actuators can be used or the rotary motion of the actuator can be converted to linear. Another solution is tilting plates in the style of venetian blinds. The shutter configuration of FIG. 5 requires only a space of a few mm between the collimator and the X-ray tube (the thickness of the blades), as the actuators can be places outside the flange connecting the tube to the collimator.

While the preferred embodiment uses a constant speed or constant acceleration shutter opening to reduce the radiation outside the ROI, other speed profiles can be used. For shutters with very high speed movement such as 2-7 mS, the shutter can simply fully open, for all or some exposures, for the last part of the X-Ray pulse which is typically 10-20 mS long. Such high speeds can be achieved by using thinner lead blades, for example. The speed profile can be tailored to the importance of the data, with area of less importance outside the ROI getting less exposure. The invention covers any system which has more than one level of exposure during one X-Ray pulse or during one image capture sequence and hence can also be used in systems where the X-Ray tube is on continuously.

The disclosed invention is described above in the context of fluoroscopy machines; however it is easily foreseeable that the disclosed invention can be applied to any device that would benefit from a dynamically-varied exposure level. Some examples are external beam radiation therapy machines, computed tomography devices and other devices in which the disclosed invention may or may not be used specifically for attenuating radiation. Similarly, applications wherein the disclosed invention is applied are not limited to imaging devices, such as radiation therapy.

We claim:

1. A device comprising an X-Ray shutter with at least one moveable X-Ray attenuating blade that acquires images while at least one blade is in motion.

2. A device as in claim 1, wherein said moving blades create a non-uniform exposure and act as a dynamic continuously-varying filter.

3. A device as in claim 1, wherein said shutter movement is dynamically computed.

4. A device as in claim 1, wherein the exposure of said image is dynamically corrected using a look-up table.

5. A device as in claim 1, wherein said images acquired while at least one shutter blade is in motion is dynamically blended with other images.

6. A device as in claim 1, wherein said images can be acquired using a plurality of blade movement patterns and can differ between acquisitions.

7. A method that acquires an X-Ray image while at least one shutter blade is in motion comprising:
dynamically moving at least one shutter blade; acquiring X-Ray image partially attenuated by said shutter blades.

8. A method as in claim 6, wherein said blade movement creates a non-uniform exposure and acts as a dynamic continuously-varying filter.

9. A method as in claim 6, wherein said shutter movement is dynamically computed.

10. A method as in claim 6, wherein the exposure of said image is dynamically corrected using a look-up table.

11. A method as in claim 6, wherein said images acquired while at least one shutter blade is in motion is dynamically blended with other images.

12. A method as in claim 6, wherein said images can be acquired using a plurality of blade movement patterns and can differ between acquisitions.

13. An X-Ray shutter comprising of a plurality of movable X-Ray attenuating blades, said shutter having at least one blade moving during a radiation exposure, said movement creating a non-uniform exposure profile with higher exposure assigned to areas of higher interest.

14. A device as in claim 13, wherein said moving blades create a non-uniform exposure and, therefore, act as a continuously-varying filter.

15. A device as in claim 13, wherein said shutter movement is dynamically computed.

16. A device as in claim 13, wherein the exposure of an acquired image or sensed signal is dynamically corrected using a look-up table.

17. A device as in claim 13, wherein any images acquired while at least one shutter blade is in motion can be dynamically blended with other images or signals.

18. A device as in claim 13, wherein a plurality of blade movement patterns can be used and can differ between radiation sequences.
